(19) United States
(12) Patent Application Publication
(10) Pub. No.: US 2019/0247263 A1
(43) Pub. Date: Aug. 15, 2019

(54) CRUTCH

(71) Applicant: Shih- Chieh Liu, Changhua (TW)

(72) Inventor: Shih- Chieh Liu, Changhua (TW)

(73) Assignee: HOMECARE ENTERPRISE CO., LTD., CHANGHUA (TW)

(21) Appl. No.: 16/265,701

(22) Filed: Feb. 1, 2019

(30) Foreign Application Priority Data
Feb. 13, 2018 (TW) 107202284

(51) Int. Cl. A61H 3/02

(52) U.S. Cl. CPC A61H 3/0288

(57) ABSTRACT

A crutch may include a tube body, a first round bar, and a second round bar. The tube body has a main channel and a second channel which are axially and separately formed inside the tube body in parallel. A plurality of first locating holes and a plurality of second locating holes are respectively formed on peripheries of the main channel and the second channel, and a bottom cap disposed on a first end of the tube body is configured to block the main channel. Also, the bottom cap has a second opening formed at a position corresponding to the second channel. A top cap disposed on a second end of the tube body is adapted to block the second channel, and a main opening is formed on the top cap at a position corresponding to the main channel. Moreover, a handle is laterally extended from the top cap.

### FIELD OF THE INVENTION

The present invention relates to a crutch and more particularly to a crutch that is easy to adjust length thereof.

### BACKGROUND OF THE INVENTION

A conventional crutch comprises an outer tube, an inner tube, a second tube, and a plurality of locating member pairs. Each of the locating member pairs has an elastic piece and a locating bolt, and the second tube is disposed in the outer tube and configured to shift inside the outer tube so as to adjust the overall length between the outer tube and the second tube. The locating member pair is installed in the second tube, and the locating bolt is configured to pass through a through hole of the second tube and to engage in a first locating hole of the outer tube so as to enable a position of the second tube to be secured after fully stretched. Moreover, a plurality of second locating holes vertically formed on an outer periphery of the inner tube, and the locating bolt is configured to penetrate through the through hole of the second tube and the second locating hole of the inner tube such that the inner tube inserted into the second tube is adapted to be secured after stretched.

However, the conventional crutch has following disadvantages: (i) for preventing the outer tube, the second tube, and the inner tube from rotating relative to each other, they are usually shaped into a non-circular tube, and the tubes are adapted to be stretched in a same straight line. Thus, after the crutch is adjusted in length, the locating bolt is configured to pass through the holes in sequence, which is a slow way and is not easy in operation. Furthermore, when the tubes are formed in round tubes and sleeved together, the tubes are prone to rotate relative to each other, which is difficult to achieve the purpose of easy operation and simple adjustment. Therefore, there remains a need for a new and improved design for a crutch to overcome the problems presented above.

### SUMMARY OF THE INVENTION

The present invention provides a crutch which comprises a tube body, a first round bar, and a second round bar. The tube body has a main channel and a second channel which are axially and separately formed inside the tube body in parallel. A plurality of first locating holes and a plurality of second locating holes are respectively formed on peripheries of the main channel and the second channel, and a bottom cap disposed on a first end of the tube body is configured to block the main channel. Also, the bottom cap has a second opening formed at a position corresponding to the second channel. A top cap disposed on a second end of the tube body is adapted to block the second channel, and a main opening is formed on the top cap at a position corresponding to the main channel. Moreover, a handle is laterally extended from the top cap. The first round bar disposed in the main channel of the tube body is configured to upwardly stand out of the main opening to connect to an armpit pad. A first elastic piece is installed in the first round bar, and a first protruding portion is formed on the first elastic piece. A first through hole is formed on the first round bar, and the first protruding portion is adapted to pass through the first through hole and one of the first locating holes so as to secure the length of the first round bar extending out of the tube body and adjust the distance between the armpit pad and the handle. The second round bar disposed in the second channel of the tube body is adapted to downwardly stand out of the second opening to connect to an elastic pad, and a second elastic piece is installed in the second round bar, and a second protruding portion is formed on the second elastic piece. Moreover, a second through hole is formed on the second round bar, and the second protruding portion is adapted to pass through the second through hole and one of the second locating holes so as to secure the length of the second round bar extending out of the tube body and adjust the height of the crutch when the elastic pad abutting against the floor.

In one embodiment, each of the first locating holes are located in line and separated with same interval on the main channel while each of the second locating holes are located in line and separated with same interval on the second channel, and the first locating holes and the second locating holes are arranged on the same vertical line; when the first round bar is axially rotated, the first protruding portion is adapted to be detached from one of the first locating holes and deviated from the vertical line where the first locating holes are arranged; when the second round is axially rotated, the second protruding portion is adapted to be detached from one of the second locating holes and deviated from the vertical line where the second locating holes are arranged; the first round bar or the second round bar is axially moved along the inner wall of the tube body and is rotated back to enable the first protruding portion or the second protruding portion to engage with one of the first locating holes or one of the second locating holes at corresponding height so as to achieve the effect of quick adjustment in length.

In another embodiment, the handle and the armpit pad are formed in parallel which laterally protrude from a side of the tube body at the second end of the tube body.

In still another embodiment, an inner end of the first round bar located in the tube body has a first plug disposed thereon while an inner end of the second round bar located in the tube body comprises a second plug disposed thereon, and the first plug and the second plug respectively have a first elastic portion and a second elastic portion to abut against an inner wall of the tube body so as to form resistance when the first round bar and the second round bar moving relative to the tube body.

In a further embodiment, a scale marks is formed on a surface of the first round bar.

A user can press the first protruding portion of the first elastic piece to release the first round bar from the main channel and rotate the first round bar axially to shift the first protruding portion from the line of the first locating holes such that the first round bar can be pulled vertically to move relative to the tube body to a designated length and be rotated back to enable the first protruding portion to engage one of the first locating holes at corresponding height, thereby quickly adjusting the distance between the armpit pad and the handle. Similarly, the second round bar can be released and quickly adjusted to a designated height so as to adjust the distance between the handle and the elastic pad which is abutted against the floor.

### BRIEF DESCRIPTION OF THE DRAWINGS

FIG. 1 is a three-dimensional view of a crutch of the present invention.

FIG. 2 is a three-dimensional exploded view of the crutch of the present invention.

FIG. 3 is a sectional view of the crutch of the present invention.

FIG. 4 is a partial enlarged sectional diagram illustrating a second round bar of the crutch of the present invention is operated.

FIG. 5 is a partial enlarged sectional diagram illustrating a first round bar of the crutch of the present invention is operated.

FIG. 6 is a schematic view illustrating a first protruding portion and a second protruding portion of the crutch are pressed inwardly to release the first round bar and the second round bar from the tube body in the present invention.

FIG. 7 is a schematic view illustrating the first round bar and the second round bar are rotated axially to enable the length of the crutch of the present invention to be adjusted.

FIG. 8 is a schematic view illustrating the length of the crutch of the present invention is extended.

FIG. 9 is a schematic view illustrating the first round bar and the second round bar are rotated back to enable the length of the crutch of the present invention to be secured.

FIG. 10 is a sectional view of the crutch of the present invention after extending.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

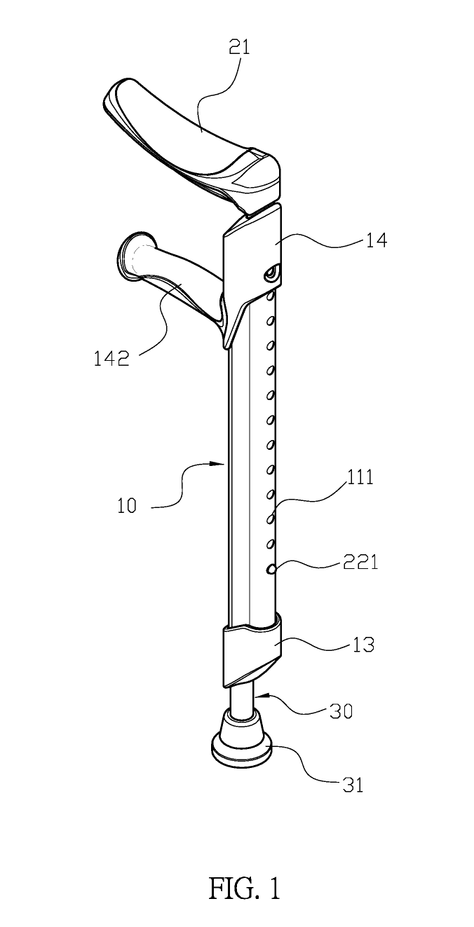

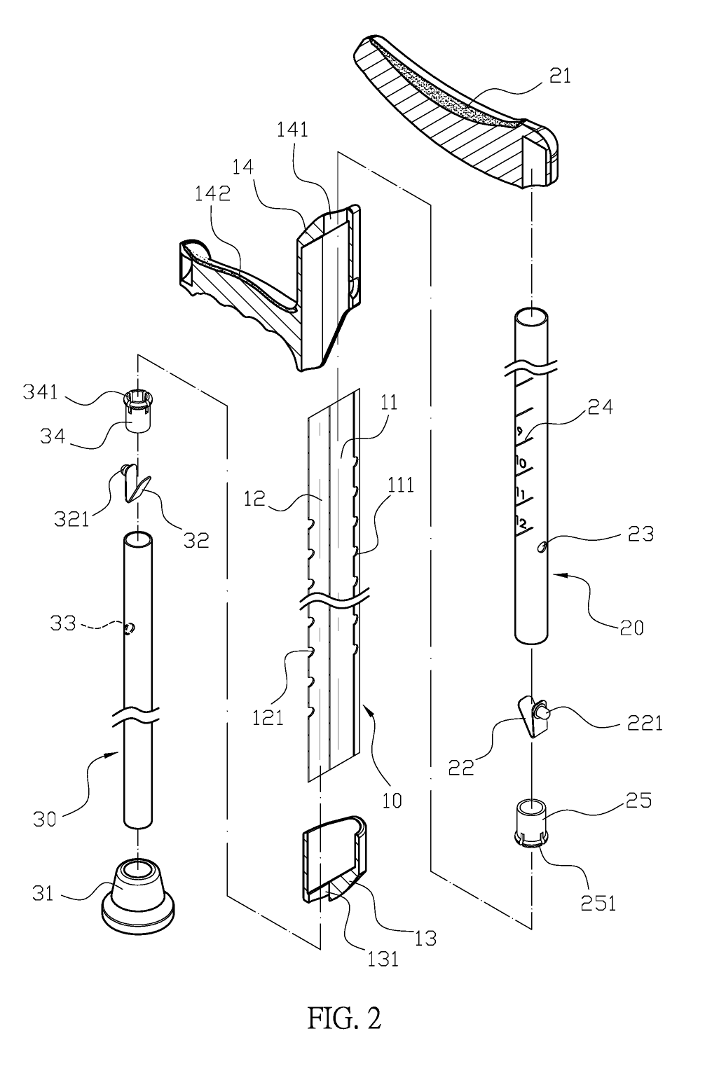

Referring to FIGS. 1 and 2, the present invention provides a crutch which comprises a tube body (10), a first round bar (20), and a second round bar (30). The tube body (10) has a main channel (11) and a second channel (12) which are axially and separately formed inside the tube body (10) in parallel. A plurality of first locating holes (111) and a plurality of second locating holes (121) are respectively formed on peripheries of the main channel (11) and the second channel (12), and a bottom cap (13) disposed on a first end of the tube body (10) is configured to block the main channel (11). Also, the bottom cap (13) has a second opening (131) formed at a position corresponding to the second channel (12). A top cap (14) disposed on a second end of the tube body (10) is adapted to block the second channel (12), and a main opening (141) is formed on the top cap (14) at a position corresponding to the main channel (11). Moreover, a handle (142) is laterally extended from the top cap (14). The first round bar (20) disposed in the main channel (11) of the tube body (10) is configured to stand out of the main opening (141) to connect to an armpit pad (21). Furthermore, the handle (142) and the armpit pad (21) are formed in parallel at the second end of the tube body (10), and a first elastic piece (22) is installed in the first round bar (20), and a first protruding portion (221) is formed on the first elastic piece (22). Additionally, a first through hole (23) is formed on the first round bar (20), and the first protruding portion (221) is adapted to pass through the first through hole (23) and one of the first locating holes (111) so as to secure the length of the first round bar (20) extending out of the tube body (10) and adjust the distance between the armpit pad (21) and the handle (142). Also, a scale marks (24) is formed on a surface of the first round bar (20) for a user to visually determine whether the extending distance is applicable. The second round bar (30) disposed in the second channel (12) of the tube body (10) is adapted to stand out of the second opening (131) to connect to an elastic pad (31), and a second elastic piece (32) is installed in the second round bar (30), and a second protruding portion (321) is formed on the second elastic piece (32). Moreover, a second through hole (33) is formed on the second round bar (30), and the second protruding portion (321) is adapted to pass through the second through hole (33) and one of the second locating holes (121) so as to secure the length of the second round bar (20) extending out of the tube body (10) and adjust the height of the crutch when the elastic pad (31) abutting against the floor. Furthermore, an inner end of the first round bar (20) located in the tube body (10) has a first plug (25) disposed thereon while an inner end of the second round bar (30) located in the tube body (10) comprises a second plug (34) disposed thereon, and the first plug (25) and the second plug (34) respectively have a first elastic portion (251) and a second elastic portion (341) to abut against an inner wall of the tube body (10) so as to form resistance when the first round bar (20) and the second round bar (30) moving relative to the tube body (10). Each of the first locating holes (111) are located in line and separated with same interval on the main channel (11) while each of the second locating holes (121) are located in line and separated with same interval on the second channel (12), and the first locating holes (111) and the second locating holes (121) are arranged on the same vertical line. When the first round bar (20) is axially rotated, the first protruding portion (221) is adapted to be detached from one of the first locating holes (111) and deviated from the vertical line where the first locating holes (111) are arranged. Similarly, when the second round (30) is axially rotated, the second protruding portion (321) is adapted to be detached from one of the second locating holes (121) and deviated from the vertical line where the second locating holes (121) are arranged. Thus, the first round bar (20) or the second round bar (30) is axially moved along the inner wall of the tube body (10) and is rotated back to enable the first protruding portion (221) or the second protruding portion (321) to engage with one of the first locating holes (111) or one of the second locating holes (121) at corresponding height so as to achieve the effect of quick adjustment in length.

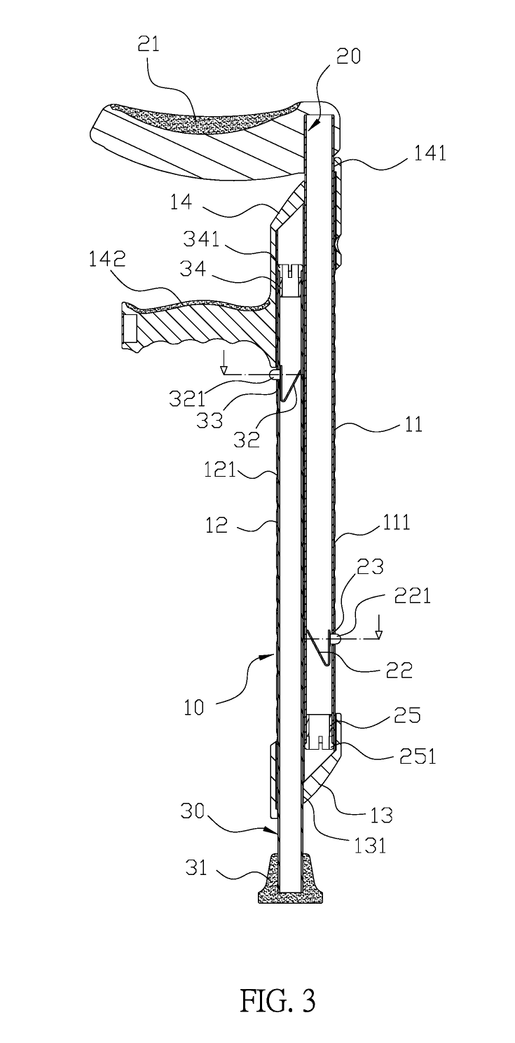

Structurally, referring to FIGS. 1 to 3, the first elastic piece (22) is installed in the first round bar (20), and the first protruding portion (221) is adapted to pass through the first through hole (23) of the first round bar (20). Two ends of the first round bar (20) are respectively connected to the armpit pad (21) and the first plug (25), and the first round bar (20) is inserted into the main channel (11) of the tube body (10) through the inner end thereof which has the first plug (25) to enable the other end thereof which comprises the armpit pad (21) to upwardly stand out of the main opening (141) of the top cap (14). Also, the first protruding portion (221) of the first elastic piece (22) is configured to engage with one of the first locating holes (111) of the main channel (11). The top cap (14) is disposed on a top end of the tube body (10) to block the second channel (12) at the top end. Furthermore, the outer diameter of the main opening (141) is smaller than the first elastic portion (251) of the first plug (25) so as to prevent the first round bar (20) from detached from the tube body (10). On the other hand, the second elastic piece (32) is installed in the second round bar (30), and the second protruding portion (321) is adapted to pass through the second through hole (33). Two ends of the second round bar (30) are respectively connected to the elastic pad (31) and the second plug (34), and the second round bar (30) is inserted through the second opening (131) of the bottom cap (13) into the second channel (12) of the tube body (10) through the end having the second plug (34), and the elastic pad (31) is positioned out of the second opening (131). Also, the second protruding portion (321) of the second elastic piece (32) is engaged with one of the second locating holes (121) of the second channel (12). The bottom cap (13) is disposed on a bottom end of the tube body (10) to block the main channel (11) at the bottom end. Moreover, the outer diameter of the second opening (131) is smaller than the second elastic portion (341) of the second plug (34) so as to prevent the second round bar (30) from detached from the tube body (10).

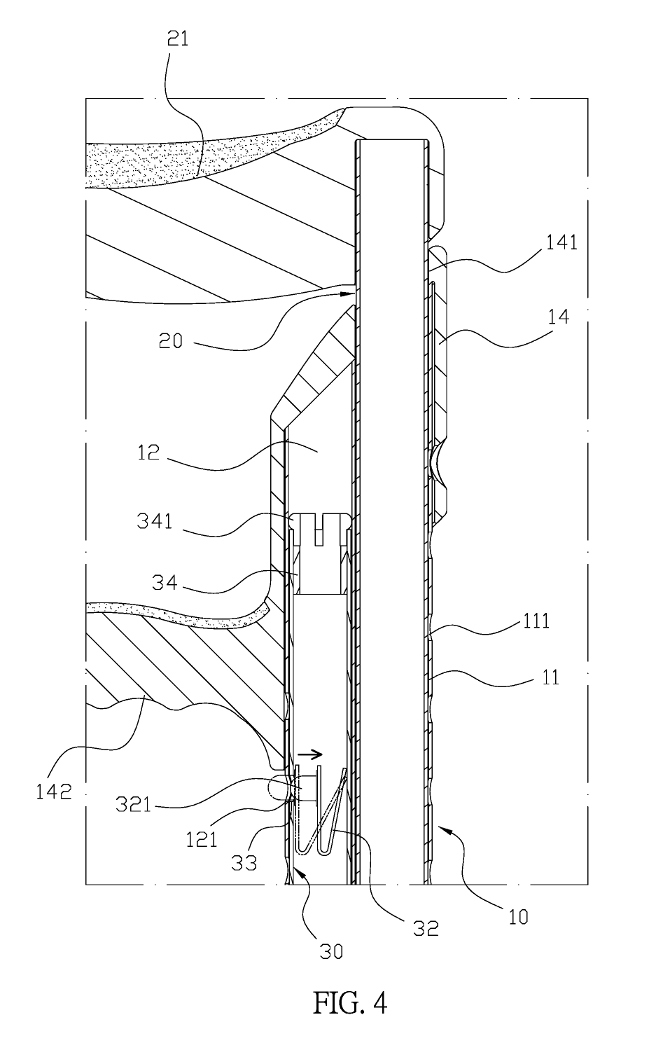

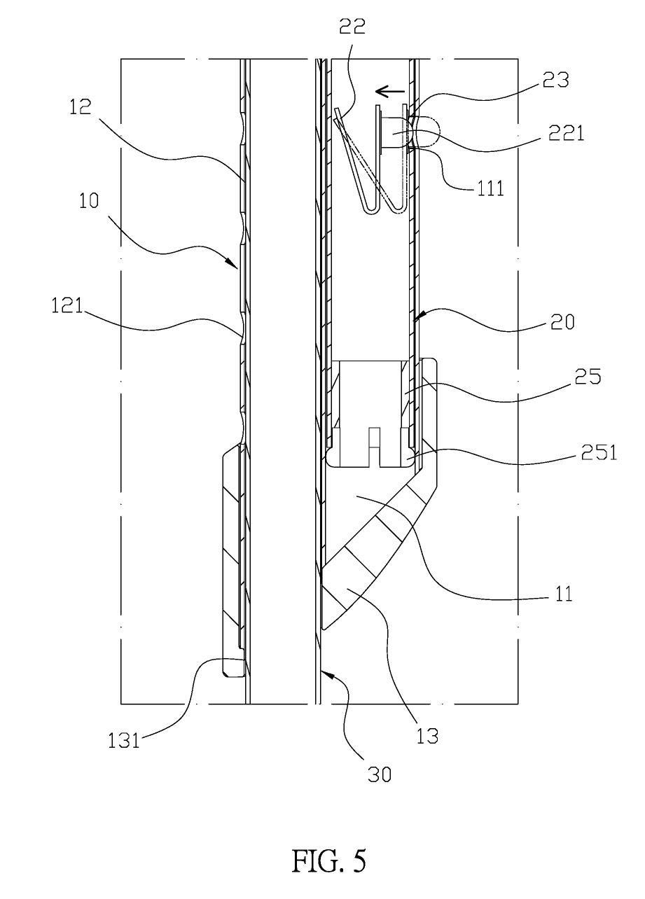

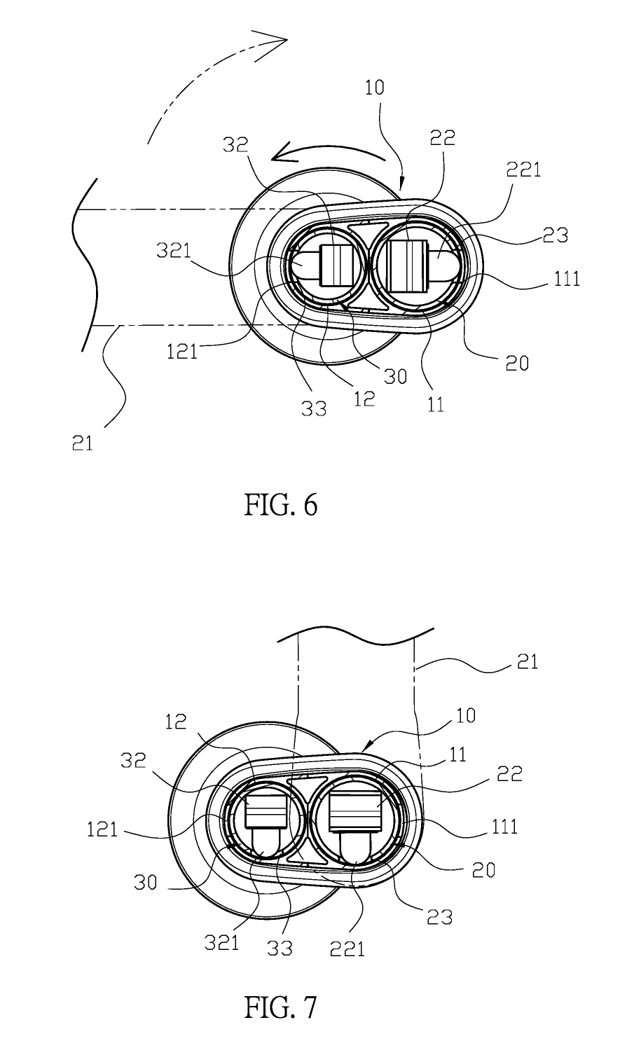

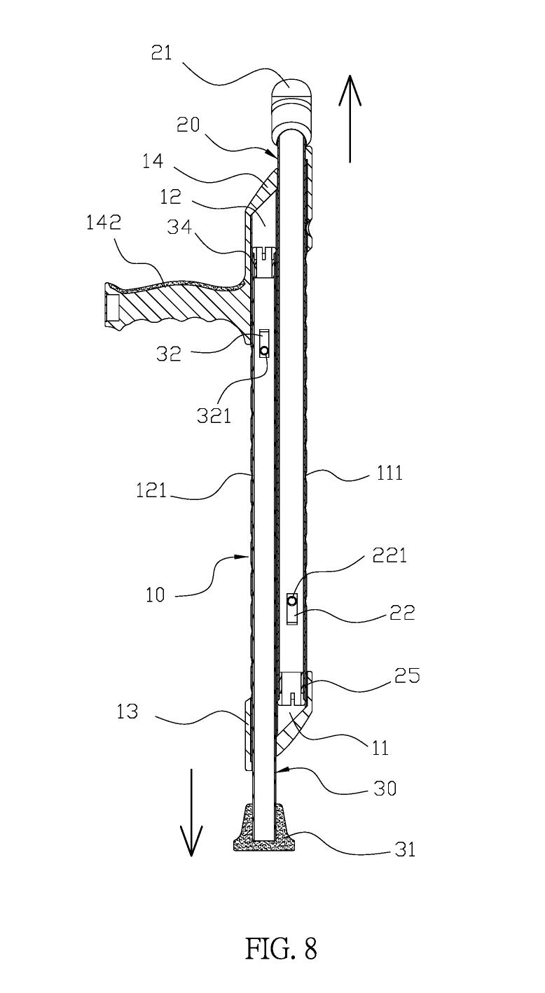

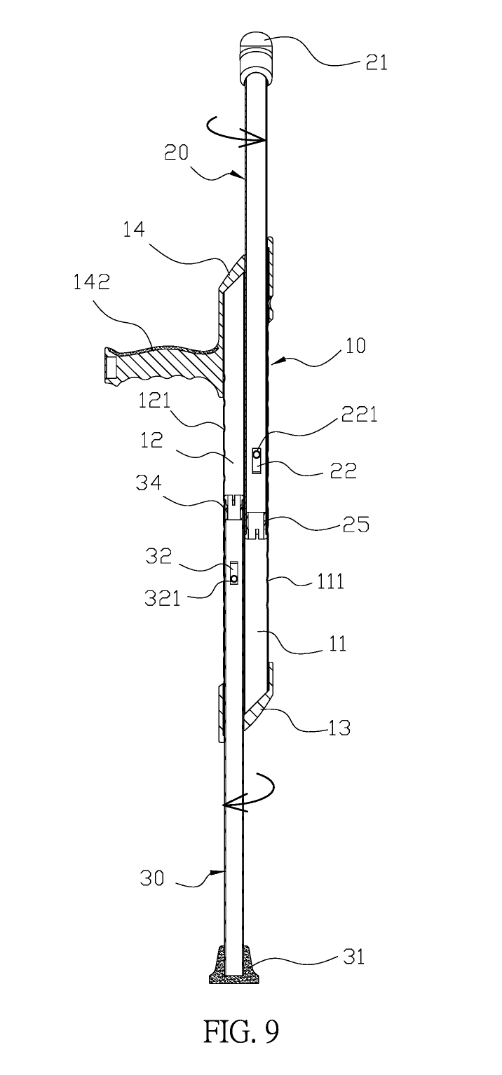

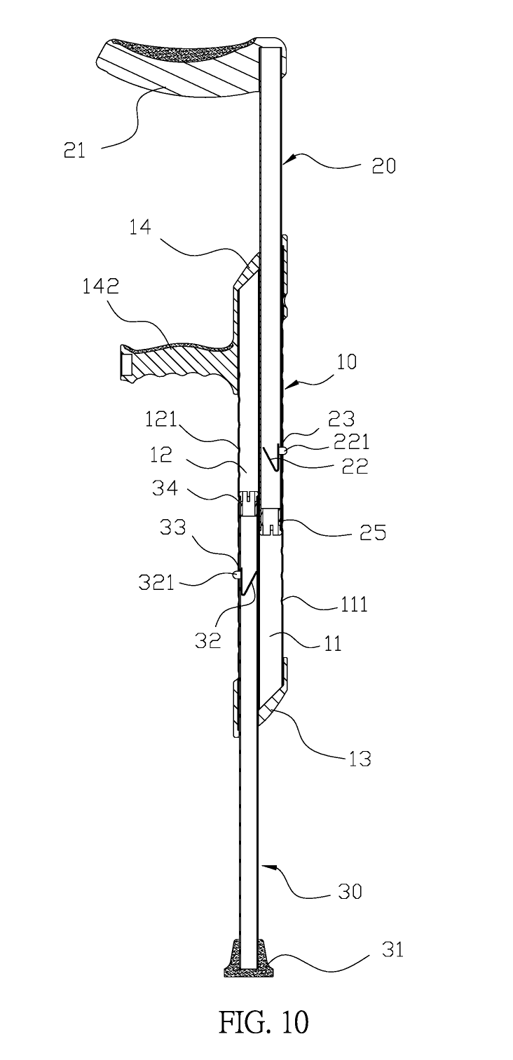

In actual application, referring to FIGS. 1 to 10, when the length of the crutch of the present invention needs to be adjusted, a user can press the first protruding portion (221) of the first elastic piece (22) inwardly which protrudes out of the first round bar (20) so as to release the first round bar (20) from the main channel (11) of the tube body (10). Thus, when the first round bar (20) is rotated axially, the first protruding portion (221) is adapted to be shifted far from the line of the first locating holes (111). At this moment, the first protruding portion (221) of the first elastic piece (22) is configured to abut against an inner wall of the main channel (11), and the first round bar (20) can be pulled vertically to move relative to the tube body (10) to a designated length and be rotated back so as to enable the first protruding portion (221) to engage with one of the first locating holes (111) at a corresponding height, thereby quickly adjusting the distance between the armpit pad (21) and the handle (142). Thus, the armpit pad (21) can be abutted against the armpit of the user and the same hand of the user can hold the handle (142) to operate the crutch. Similarly, the user can press the second protruding portion (321) of the second elastic piece (32) inwardly which protrudes out of the second round bar (30) so as to release the second round bar (30) from the second channel (12) of the tube body (10). Thus, when the second round bar (30) is rotated axially, the second protruding portion (321) is adapted to be shifted far from the line of the second locating holes (121). Meanwhile, the second protruding portion (321) of the second elastic piece (32) is configured to abut against an inner wall of the second channel (12), and the second round bar (30) can be pulled vertically to move relative to the tube body (10) to a designated length and be rotated back so as to enable the second protruding portion (331) to engage with one of the second locating holes (121) at a corresponding height, thereby quickly adjusting the distance between the handle (142) and the elastic pad (31) which is abutted against the floor.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A crutch comprising:
a tube body having a main channel and a second channel which are axially and separately formed inside the tube body in parallel; a plurality of first locating holes and a plurality of second locating holes respectively formed on peripheries of the main channel and the second channel, and a bottom cap, which is disposed on a first end of the tube body, configured to block the main channel, and the bottom cap having a second opening formed at a position corresponding to the second channel; a top cap, which is disposed on a second end of the tube body, adapted to block the second channel, and a main opening formed on the top cap at a position corresponding to the main channel; a handle laterally extended from the top cap;
a first round bar, which is disposed in the main channel of the tube body, configured to upwardly stand out of the main opening to connect to an armpit pad; a first elastic piece installed in the first round bar, and a first protruding portion formed on the first elastic piece; a first through hole formed on the first round bar, and the first protruding portion adapted to pass through the first through hole and one of the first locating holes so as to secure the length of the first round bar extending out of the tube body and adjust the distance between the armpit pad and the handle; and
the second round bar, which is disposed in the second channel of the tube body, adapted to downwardly stand out of the second opening to connect to an elastic pad, and a second elastic piece installed in the second round bar, and a second protruding portion formed on the second elastic piece; a second through hole formed on the second round bar, and the second protruding portion adapted to pass through the second through hole and one of the second locating holes so as to secure the length of the second round bar extending out of the tube body and adjust the height of the crutch as the elastic pad abutting against the floor.

2. The crutch of claim 1, wherein each of the first locating holes are located in line and separated with same interval on the main channel while each of the second locating holes are located in line and separated with same interval on the second channel, and the first locating holes and the second locating holes are arranged on the same vertical line; when the first round bar is axially rotated, the first protruding portion is adapted to be detached from one of the first locating holes and deviated from the vertical line where the first locating holes are arranged; when the second round is axially rotated, the second protruding portion is adapted to be detached from one of the second locating holes and deviated from the vertical line where the second locating holes are arranged; the first round bar or the second round bar is axially moved along the inner wall of the tube body and is rotated back to enable the first protruding portion or the second protruding portion to engage with one of the first locating holes or one of the second locating holes at corresponding height so as to achieve the effect of quick adjustment in length.

3. The crutch of claim 1, wherein the handle and the armpit pad are formed in parallel which laterally protrude from a side of the tube body.

4. The crutch of claim 1, wherein an inner end of the first round bar located in the tube body has a first plug disposed thereon while an inner end of the second round bar located in the tube body comprises a second plug disposed thereon, and the first plug and the second plug respectively have a first elastic portion and a second elastic portion to abut against an inner wall of the tube body so as to form resistance when the first round bar and the second round bar moving relative to the tube body.

5. The crutch of claim 1, wherein a scale marks is formed on a surface of the first round bar.
